(19) United States
(12) Patent Application Publication
(10) Pub. No.: US 2009/0223491 A1
(43) Pub. Date: Sep. 10, 2009

(54) Variable compression ratio engine

(76) Inventors: Ahmed Syed, Toronto (CA); Ather Rashid Dar, Honolulu, HI (US)

Correspondence Address: AHMED SYED, 6 BUD CT., HAUPPAUGE, NY, 11788, US

(21) Appl. No.: 12/074,649

(22) Filed: Mar. 5, 2008

(51) Int. Cl. F02B 75/04; F02D 15/04

(52) U.S. Cl. 123/48 A

(57) ABSTRACT

A variable compression ratio mechanism for continuously varying the compression ratio of an internal combustion engine while minimizing the power requirement and providing internal clamping to isolate the setting mechanism from the reaction to combustion loads. The mechanism includes a setting cam (1501) actuated via an innovative torque storage system acting on an auxiliary piston (203) in the combustion chamber crown. The mechanism provides very fast and precise transient response without the use of hydraulic control. The invention desirably simplifies the control system and provides an elegant and compact solution for this purpose.

### CROSS-REFERENCE TO RELATED APPLICATIONS

Not Applicable

### FEDERALLY SPONSORED RESEARCH

Not Applicable

### SEQUENCE LISTING OF PROGRAM

Not Applicable

### FIELD OF THE INVENTION

The invention relates to the field of internal combustion engines and in particular to engines whose compression ratio can be varied.

### BACKGROUND OF THE INVENTION

Strict emissions standards coupled with requirements for improved fuel economy have mandated significant changes in the way automotive powertrains are designed. The primary disadvantages of the ICE arise from the fixed design points. Quantum improvements in ICE performance hinge on the successful implementation of adaptive engine geometry that is capable of dynamically optimizing key engine parameters throughout the load/speed range. Presently, design constraints are set by peak power conditions, but most driving takes place at part-load engine operation. This allows for the possibility of significantly improving overall efficiency and drivability by continuously optimizing the design factor. While this scheme is wholly applicable to spark-ignition (SI) and Diesel (CIDI) engines, it is of particular relevance to HCCI. The intrinsic difficulty of controlling combustion phasing is the most serious obstacle to successful adoption of this technology. Current experimental engines can achieve stable SOC (start of combustion) only under tightly controlled laboratory conditions and then too over a very narrow load range. In particular HCCI operation becomes unacceptable at higher loads due to early SOC. While the auto-ignition point can be influenced by a number of factors, it is directly affected by the pre-ignition pressure. This points to the need for a flexible combustion chamber responding to load in a throttled HCCI engine.

A similar advantage is gained with SI engines. The primary drawback of the fixed clearance space, apart from placing an undesirable limitation on fuel economy marginalizes the use of lean mixtures. During part-load operation the compression ratio may be proportionately increased. Flame propagation rate goes up rapidly and ignitibility is enhanced as charge density increases.

These considerations not withstanding, adaptive engine geometry is difficult to implement. Dynamic control of the kinematic structures is a major problem. In particular achieving operating point stability over the entire load range while subject to the constraints of minimized parasitic loading and stepless transition has been difficult to achieve.

### PRIOR ART

Compression ratio has the greatest impact on combustion characteristics, economy and multi-fuel capability. Ultimately large-scale adoption of VCR will be inevitable. The problems posed by VCR are considerable. Dynamic adjustment of the clearance space has posed the most formidable challenge. Successful control of this critical parameter depends on the development of a uniquely capable control system which can withstand extraordinary demands and stresses. As such it must be capable of smoothly transiting between the limits of compression while minimizing power draw on the engine and simultaneously offering very high resilience against recoil from the intense pressure of explosion. It would be particularly susceptible to these stresses during transition. Furthermore the system should be able to react quickly to load changes.

Recently there has been a surge in development of VCR systems. The prevailing strategies include: moving the cylinderhead/sleeve, variation of piston deck height, modification of connecting rod geometry, moving the crank pin, and moving the crankshaft axis among others.

The problem with variable deck height pistons such as disclosed in U.S. Pat. No. 5,191,862 and U.S. Pat. Appl. No. 2006/0102115 to Hirano is that either positive control is lacking or there is a stepwise control of the compression ratio. U.S. Pat. No. 5,329,893 teaches another approach to vary the CR by means of a tilting cylinder head. Apart from the problem of sealing, the setting mechanism is subjected to the combined inertia of the cylinderhead and attached auxiliaries. The alternate approach attempts to move the crankshaft axis relative to the cylinderhead on eccentric bearings. This method has marginal reliability arising from a rapid wear of the bearings due to the difficulty of precisely aligning them. Other designs have variously attempted to overcome the problem of bearing wear by placing the crankshaft in a cradle or assembly such as disclosed in U.S. Pat Appl. No. 2006/0112911 to Lawrence. The methods can be incompatible with V-block engines and complicate coupling the crankshaft to the flywheel/gearbox. The problem of working against the full force of the combustion gases remains.

In another approach, examples of which are given in U.S. Pat. No. 6,772,717 and published U.S. Pat. Appl. No. 2006/0137632, the connecting rod is modified to vary the stroke thereby affecting the compression ratio. The inertia of the rapidly reciprocating members places excessive strain on the setting mechanism. More complex schemes have been proposed by MCE-5 and others.

All of the above schemes also have the inherent disadvantage in that higher compression ratios can result in abnormal combustion chamber geometry leading to excessive heat loss and quenching. Apart from the peculiar disadvantages, these methods require extensive and costly modifications to the engine.

In yet another approach, an auxiliary piston is disposed in the combustion chamber crown. Most such designs have relied on hydraulic control to position the sub-piston. This entails complex plumbing in the cylinder head. The inherent problem of a number of prior solutions of the backflow of the hydraulic fluid under the intense pressure of the explosion of fuel and air, forcing the piston to a slightly rearward position is described in oft cited U.S. Pat. No. 4,516,537 ('537) to Nakahara. '537 strives to address the key issue of isolating the setting mechanism from the firing load to eliminate setting error. Other attempts to overcome the problem of backflow have reverted to a stepwise control of the compression ratio resulting in knock and erratic performance. The prior art systems did not work as expected because the regulation of the compression ratio was accompanied by too large of an error. Another U.S. Pat. No. 5,195,469 ('469) discloses a design capable of isolating the aforementioned adjustment and firing loads with a purely mechanical system. While compact, modular and very effective, the sleeve arrangement restricts the provision of support bearings at intermediate points necessary for rigidity and is susceptible to progressive twist and setting error along its length.

With regard to HCCI engines, various schemes have been advanced to control the combustion event such as disclosed in U.S. Pat. Nos. 6,953,020 7,101,964 and 7,100,567 etc. While the schemes may have some viability, the designs involve complexity of such level that limits their practical/commercial value. Other effective methods are disclosed in U.S. Pat. Nos. 6,708,655, 6,450,154 and 6,260,520. The auto-ignition is triggered by sharply boosting the cylinder pressure when the power piston is near TDC by means of a sub-piston. To be effective over the full load range however, the method needs to be augmented by maintaining the pre-boost pressure within narrow limits. In the above designs the degree of boost cannot be varied conveniently with cam driven systems and hydraulically actuated pistons will encounter the problems outlined in '537.

### SUMMARY OF THE INVENTION

It is evident from the foregoing that current designs are seriously disadvantaged in terms of cost/complexity or capability. Impractical design, low reliability and difficulty of manufacture are significant barriers eliminating them as serious contenders for production viable designs. Thus there is a compelling need for an improved arrangement to implement adaptive engine geometry.

Accordingly the present invention achieves the objectives with a simple, elegant solution having high functionality, reliability and long-term durability at low cost.

It is an object of the invention to implement an advanced control mechanism that meets the criteria of stable, error-free operation, high tolerance, low parasitic load and fast transient response.

It is another object of the invention to provide a VCR control means capable of isolating the adjustment mechanism from the reaction of firing loads.

It is also an object of the invention to provide an engine capable of smoothly switching between different operating modes and fuels.

It is yet another object of the invention to provide an engine that is suitable for mass production. These and other objectives of the present invention are achieved according to a preferred embodiment thereof to implement an improved system to control the clearance volume.

The variable clearance volume is determined by the positioning of a movable sub-piston mounted within a recessed cavity that opens upon the clearance space. The positioning of the sub-piston is effected by the rotational position of a setting cam that does away with the problematic hydraulics of earlier systems. The exemplary design features cams capable of being primed for forward movement of the volume regulating member during the neutral interval (exhaust-intake strokes), thereby minimizing the power requirement. In a further innovative step, a locking mechanism prevents the cams from backing up under the sudden rise of cylinder pressure. Stepless adjustment of the compression ratio is achieved over the entire load range. The design has the further advantage of having a very fast transient response in both directions.

The arrangement has important improvements over '469. By separating the control shaft and setting shaft the current invention provides a more robust configuration. Setting error is reduced and rigidity is enhanced by enabling support bearings at intermediate points along the length of the system. Simultaneously, flexibility is improved with regard to placement of components and accommodation with the valvetrain within the limited confines of the cylinderhead.

### BRIEF DESCRIPTION OF THE DRAWINGS

The embodiments of the invention may be more fully understood, and further objects and advantages thereof will become more apparent from the ensuing detailed description taken together with the accompanying drawings wherein similar reference characters refer to similar elements throughout.

FIG. 1 is a cross sectional view of an engine which shows a secondary cylinder positioned by a setting cam and shaft according to the principles of the invention.

FIG. 2 illustrates the setting shaft with ratchets and the cam with locking mechanism.

FIG. 3 is a detailed view of the setting cam and drive gear.

FIG. 4 shows a cross-sectional view of an alternate embodiment with torque storage means disposed between control shaft and gear.

FIG. 5 illustrates in perspective view a partially assembled arrangement of the invention with mountings.

### DETAILED DESCRIPTION OF THE PREFERRED EMBODIMENTS

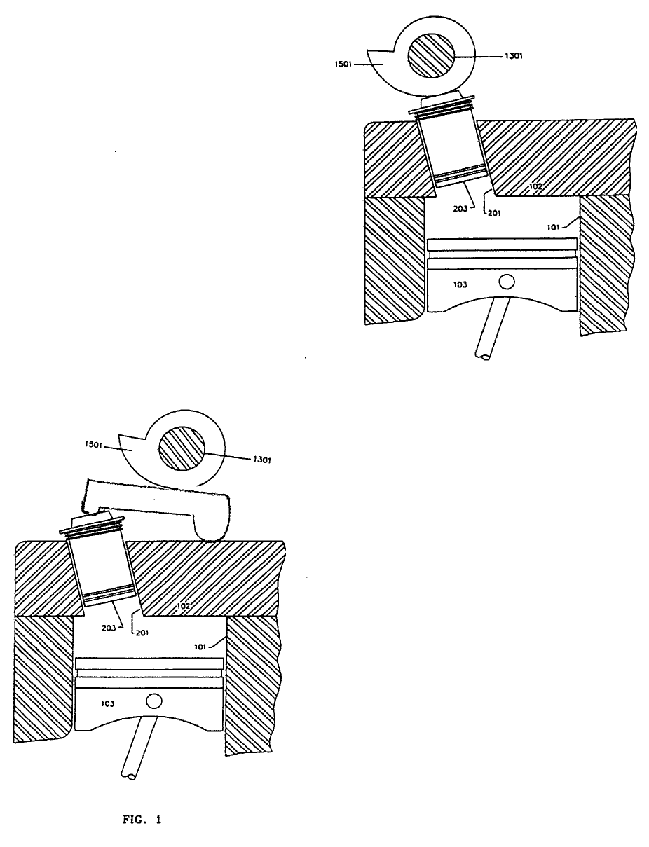

Referring now to the drawings, there is illustrated in FIG. 1 a sectional view of a cylinder in an internal combustion engine generally designated 10. The engine has a primary cylinder 101, a cylinder head 102, and a primary piston 103. A secondary cylinder 201 is formed in the cylinder head 102 and positioned so that the opening of the secondary cylinder 201 corresponds with a selected part of the volume which comprises the clearance volume at TDC. A secondary piston 203 is mounted within the secondary cylinder 201. The space below the piston 203 is added to the clearance volume in computing the compression ratio. As the secondary piston is lowered along the cylinder 201, the clearance volume is reduced and the compression ratio is increased. The opening of the secondary cylinder can be made as a narrow orifice.

In the embodiment shown in FIG. 1, the spark plug may be mounted within the secondary piston or elsewhere according to preference. The secondary piston will incorporate rings etc. for sealing and lubrication, details of which are not shown as they are well known in the art and not taught by the invention.

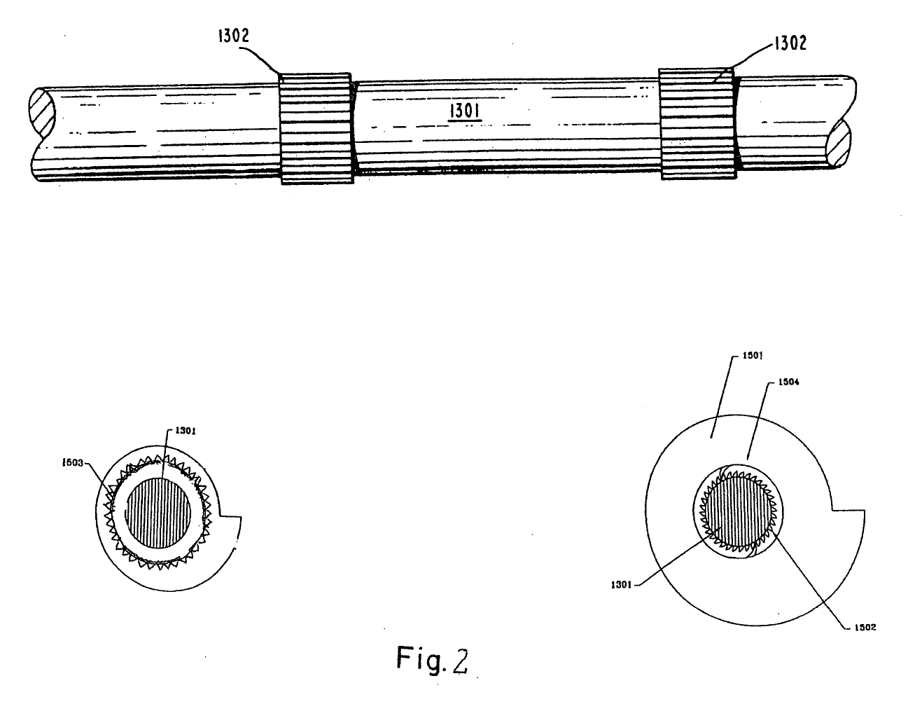

FIG. 2 depicts a setting-shaft 1301 on which are formed ratchets 1302 at intervals corresponding to the cylinders. A setting-cam 1501 to which a gear means 1503 is attached co-axially on one side. The gear is engageable with a corresponding gear 1402 on the control-shaft 1401. The hub 1504 mounts a locking mechanism 1502 which engages the corresponding ratchets in the setting-shaft to enforce unidirectional rotation of the cams relative to the setting-shaft. One cam 1501 with locking mechanism 1502 is mounted onto the setting-shaft 1301 over each ratchet 1302.

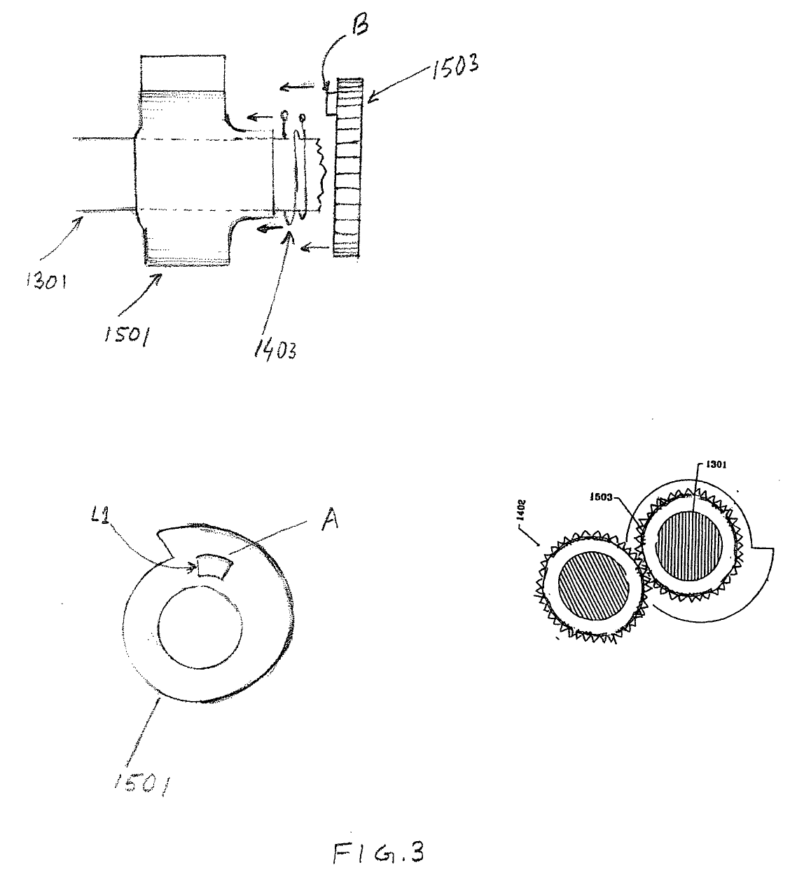

Referring now to FIG. 3, the gear 1503 co-rotates with the cam in a way that allows it a limited degree of free rotation relative to the cam. In the exemplary embodiment the free rotation is limited by end stops formed by a recess A in the cam into which a projecting section B of the gear wheel abuts. The free rotation of the gear is restricted by a spring or torsion means so disposed between gear and cam that it biases the gear in a counter clockwise direction against the stop L1 as viewed in FIG. 3. The spring means 1403 is compressible by the closing of the loading gap defined by the 2 end-stops to communicate torque from the drive gear 1402 in the direction of increasing compression ratio. Turning of the control shaft is controlled by a servomotor. In the preferred embodiment, a gear 1404 is formed on a selected portion of the control shaft to allow engagement with the motor actuator by a directly coupled gear transmission.

Upon rotation of the control shaft in the desired direction and loading of the spring 1403, the arrangement is primed to have the cam move in the desired direction upon the occurrence of pressure in the combustion chamber as communicated to the setting-cam 1501 by the secondary piston described above being lower than the spring 1403 coefficient. This movement of the cam 1501 relieves the tension in the spring allowing the cam gear 1503 to be once again abutted with end-stop L1. The setting-cam is prevented from rotating in the opposite direction by the one-way locking mechanism mounted in the hub of the cam engaging the ratchet 1302. In the exemplary embodiment a ratchet is shown, but can be any mechanism known in the art that imposes unidirectional rotation.

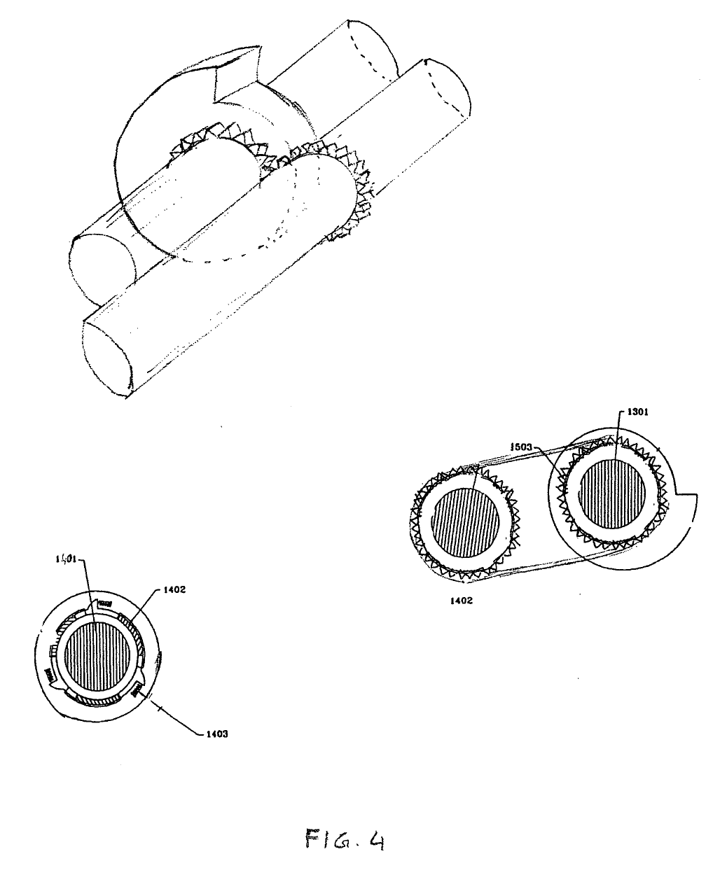

In an alternative configuration shown in FIG. 4 the loading gap is defined by free play between the drive gear 1402 and control shaft 1401 between two end stops. A biasing spring disposed there between serves the same purpose. The drive gear may also be formed as a rack in which case the control shaft would act as a plunger with a force storage means such as a spring disposed between the rack and plunger.

The servomotor and drive mechanism may be housed separately outside the camshaft cover. The rotation and positioning of the servomotor is controlled by the engine management computer.

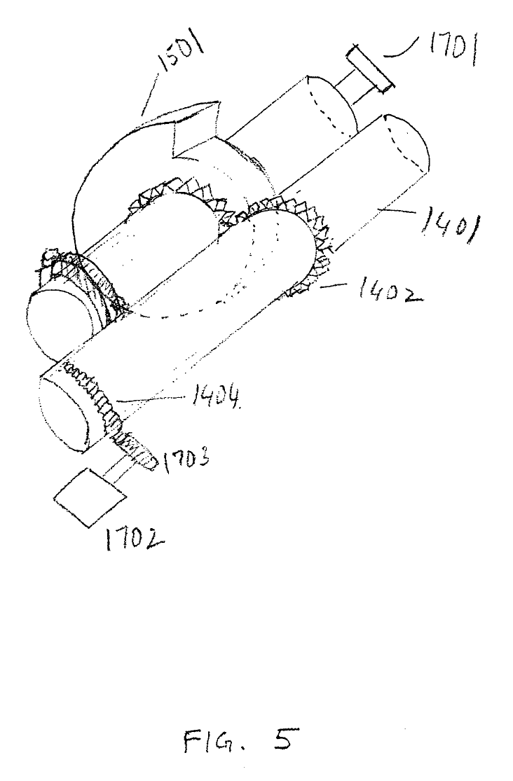

FIG. 5 shows the embodiment assembled with bracings at intermediate points. A stepper motor 1702 is depicted as having a transmission gear 1703 engaging the drive gear 1404 of control-shaft 1401. The setting-cam is rotated into the desired forward position under a controller connected to the stepper motor. To reverse the position of the cam 1501, a clutch mechanism 1701 at one end of the setting-shaft 1301 is released which allows the setting-shaft and the entire arrangement with it, to rotate in the direction of lower compression. The cam 1501 may thereby be continuously repositioned (micro-adjusted) to compensate for changing load or, drifting cylinder temperature gradient. The return motion may be assisted by counter rotation of the servo-motor whereby very fast transit to low compression ratio (<100 milliseconds) is achieved. To further facilitate placement of the cams a lever may be disposed between cam 1501 and secondary piston 203, such lever pivoting about an anchor point at one end or the middle. Also drive gear 1402 can engage cam gear 1503 via chain or belt.

Compared to earlier systems, problematic hydraulic controls and plumbing are eliminated allowing cost reduction and better reliability and stability while simultaneously reducing setting error.

In the exemplary embodiment the clutch disk 1701 is immovably engaged via solenoid which is released as desired under direction of the ECU. The system is designed to fail in the safe mode—loss of power or control signals or failure of the solenoid causes the system to freewheel and return to the safe low-compression state. Alternatively, the clutch disk and servo-motor may be replaced with hydraulic drive actuators similar to the type used for rotating a camshaft relative to its drive sprocket.

In an advantageous feature of the invention, the self-alignment of the cams against the end stops assures precise and uniform compression ratio across all cylinders.

In another advantageous feature, the exemplary embodiment allows a bank of cylinders to be controlled by a single actuator resulting in a compact, low cost modular design.

Further, the operating effort and parasitic loading on the engine is minimized while rigidity against recoil and isolation of the combustion load is achieved by the clamping provided internally by the arrangement.

Since certain change may be made in the above apparatus without departing from the spirit and scope of the invention herein involved, it is intended that all matter contained in the above description, as shown in the accompanying drawing, shall be interpreted in an illustrative and not a limiting sense.

What is claimed is:

1. An internal combustion engine comprising:
an engine block defining therein a combustion cylinder; a primary piston disposed in said combustion cylinder; a cylinderhead defining an end of said combustion cylinder;
said cylinderhead defining a secondary cylinder in flow communication with said combustion cylinder; and a secondary piston reciprocably disposed in said secondary cylinder; reciprocation of the secondary piston being controlled via the rotation of a cam;
said cam having drive means (1503) engageable by a corresponding drive member (1402) mounted on a separate control shaft.

2. The engine of claim 1, said cam is positioned atop and interactively with said secondary piston.

3. The engine of claim 1, a lever interposed between said cam and said secondary piston whereby said cam may be positioned away from or off-axis of the secondary piston.

4. The engine of claim 1, said cam is rotatable relative to its mounting shaft.

5. The engine of claim 4, said cam is lockable for co-rotation with its mounting shaft.

6. The engine of claim 5, said drive means having limited relative rotation to said cam, a torque storage means between drive means and cam to transmit torque to the cam upon rotation of the drive means; said control shaft driven by an electric drive motor or hydraulic drive motor.

7. The engine of claim 5, said corresponding drive member having limited relative movement to said control shaft, force storage means between corresponding drive member and control shaft whereby to transmit force to the corresponding drive member upon movement of the control shaft; movement of the control shaft affected by an electric drive motor or hydraulic drive motor.

8. An internal combustion engine comprising:
an engine block defining therein a combustion cylinder; a primary piston disposed in said combustion cylinder; a cylinderhead defining an end of said combustion cylinder;
said cylinderhead defining a secondary cylinder in flow communication with said combustion cylinder; and a secondary piston reciprocably disposed in said secondary cylinder; reciprocation of the secondary piston being controlled via the rotation of a cam;
said cam rotatable relative to its mounting shaft (1301) and having drive means (1503) engageable by a corresponding drive member (1402) mounted on a separate control shaft.

9. The engine of claim 8, said cam is lockable for co-rotation with its mounting shaft.

10. The engine of claim 9, said cam is positioned atop and interactively with said secondary piston.

11. The engine of claim 9, a lever interposed between said cam and said secondary piston whereby said cam may be positioned away from or off-axis of the secondary piston.

12. The engine of claim 9, said drive means having limited relative rotation to said cam, a torque storage means between drive means and cam to transmit torque to the cam upon rotation of the drive means; said control shaft driven by an electric drive motor or hydraulic drive motor.

13. The engine of claim 9, said corresponding drive member having limited relative movement to said control shaft, force storage means between corresponding drive member and control shaft whereby to transmit force to the corresponding drive member upon movement of the control shaft; movement of the control shaft affected by an electric drive motor or hydraulic drive motor.

14. The engine of claim 9, wherein said flow communication between said combustion cylinder and said secondary cylinder is via narrow orifice.

15. The engine of claim 12, said drive means is a gear drive means engaging a corresponding gear drive.

16. The engine of claim 12, said torque storage means is a spring.

17. The engine of claim 13, said force storage means is a spring.

18. A method for operating an engine comprising:
providing a combustion cylinder having a cylinderhead at an end thereof and a primary piston reciprocally disposed in the combustion cylinder defining a combustion chamber;
providing a secondary cylinder in flow communication with said combustion chamber;
and a secondary piston reciprocally disposed in the secondary cylinder; and
reciprocating the secondary piston in the secondary cylinder so as to maintain an optimal compression ratio for different engine load conditions.

19. The method of claim 18, wherein the compression ratio is further selectable for different fuel inputs or different modes of operation.
